(19) United States
(12) Patent Application Publication
(10) Pub. No.: US 2005/0039336 A1
(43) Pub. Date: Feb. 24, 2005

(54) Double action scissors (DAS)

(76) Inventor: Grigor Garukyan, Glendale, CA (US)

Correspondence Address: Grigor Garukyan, 601 Hawthorne St. # 5, Glendale, CA, 91204, US

(21) Appl. No.: 10/894,072

(22) Filed: Jul. 19, 2004

Related U.S. Application Data
(60) Provisional application No. 60/496,546, filed on Aug. 21, 2003.

(51) Int. Cl. B26B 1/00

(52) U.S. Cl. 30/134

(57) ABSTRACT

A scissor that can perform two functions is disclosed. The Double Action Scissors (DAS) can cut objects just like ordinary scissors, but it can also hold one of the pieces of the object it cuts. The DAS is easy to manufacture due to the fact that DAS can be made from already manufactured scissors. One just needs to attach a spring-clip to the appropriate part of any scissor. The spring-clip can be made from different materials and can be spot-welded if the scissors and the spring clip are metal, or attached mechanically if they are plastic. When cutting small pieces of material, one of the pieces is held by DAS as long as the scissors are in a closed position, and released when the scissors are opened. The DAS helps keep a clean environment, its easy to use, and can perform as regular scissors as well.

### CROSS-REFERENCE TO RELATED APPLICATIONS

This non-provisional application is related to the provisional application filed on Aug. 21, 2003, application No. 60/496,546

### STATEMENT REGUARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention, DAS, is related to any mechanical process that cuts an object into two pieces and at the same time grabs either piece of that cut object.

### BRIEF SUMMERY OF THE INVENTION

DAS consists of scissors and a spring-clip, which are connected together. If the spring-clip is made of metal it is welded on to the tip of the scissors. If it is made of plastic it can be connected to the scissors by mechanical means. The spring-clip is made from a flat spring sheet, which has an unsymmetrical fold (greater than 90 degrees) resulting in that one side of the sheet being longer than the other. An additional fold opposite to the initial fold is given to the longer side. The spring-clip is set on the arm of the scissors that will move down when the scissors are used. The longer side of the spring-clip is set on the inside surface of the same arm of the scissors that will move down. For example, if the spring-clip is made of metal, and is connected to an arm of the scissors using spot welding, than one side of a material being cut, (a piece of string) gets held between the additional bend on the longer side of the clip, and the outside surface of the arm of the scissors that is moving up when the scissors are being used. The arm of the scissors that is moving up when the scissors are being used pushes one side of the string up. The string gets wedged between the fold on the long side of the spring-clip and the outside surface of the upward moving arm of the scissors. The side of the string that is on the short side of the spring-clip gets cut and released. The string wedged between the upward arm of the scissors and the fold of the long side of the spring-clip will remain wedged until the scissors are opened. When the scissors are opened the string will get released from in-between the spring-clip and the arm of the scissors due to decreased stretching of the spring-clip and the weakening of frictional forces. DAS helps doctors, electricians, tailors, and many other professions perform their jobs' easier.

### BRIEF DESCRIPTION OF THE SEVERAL VIES OF THE DRAWINGS

The invention will be described in more detail using references to the appended drawings.

FIG. 1 depicts, a view of the scissors and spring-clip before assembly.

FIG. 2 depicts, the view of the assembled DAS with a magnified detailed view of the spring-clip and welding areas.

FIG. 3 depicts, a view of the DAS and a piece of string positioned together before being cut.

FIG. 4 depicts, a view of the cut and held pieces of string by DAS after action.

FIG. 5 depicts, a broken out section view of DAS and magnified detailed view of the sectional area.

FIG. 6 depicts, a view of the spring-clip free from the scissors (before welding).

FIG. 7 depicts, a view of the spring-clip after welding with the sides further apart.

FIG. 8 depicts, a view of the spring-clip during and at the end of action (the sides of the spring-clip are at maximum distance from each other).

### DETAILED DESCRIPTION OF THE INVENTION

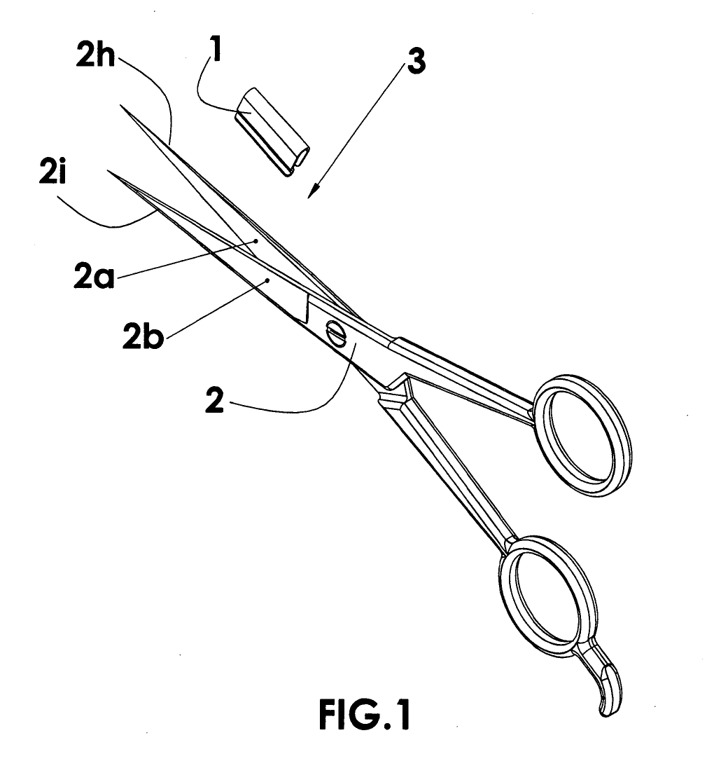

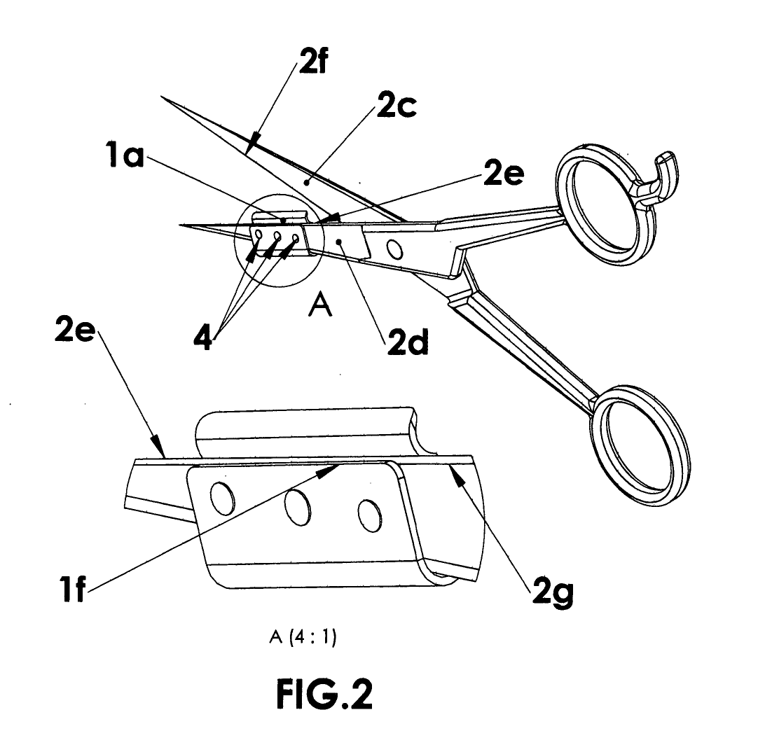

The DAS FIG. 1 is composed of spring-clip FIG. 1-1 attached to scissors FIG 1-2 (the spring-clip is welded if metallic or mechanically attached if plastic). Many types of already manufactured scissors can be used to make the DAS, the types of scissors used depend on what operation the DAS needs to be used for.

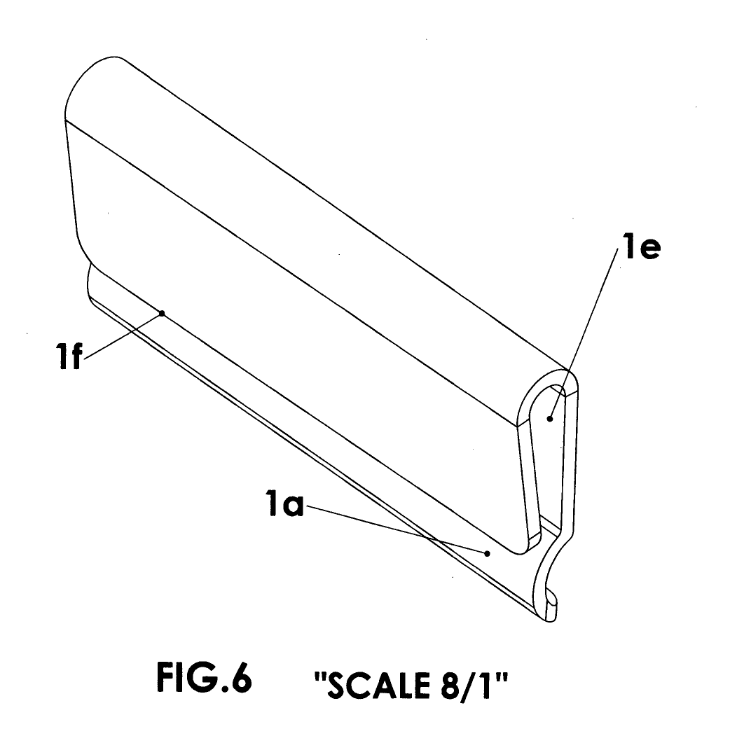

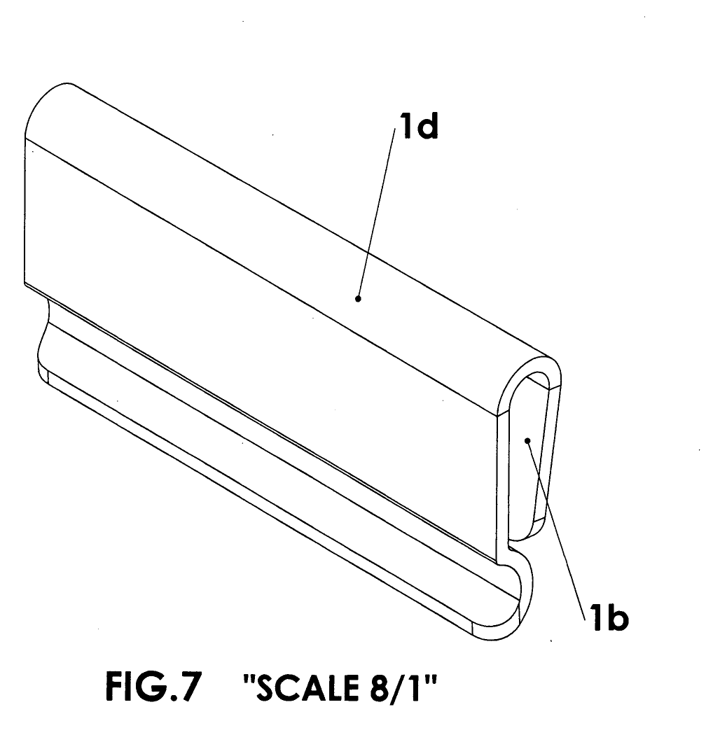

For explanatory purposes we will say that the spring-clip is metallic and the object being cut is a piece of string. The spring-clip is made from a spring sheet (which is chosen specifically for what the DAS is used for) using sheet-metal forming. Sheet-metal forming is achieved by a mechanical (blanking-bending), thermal, and electrical treatment of the sheet metal. Spring-clip FIG. 1-1 is set on scissor arm FIG. 1-2h by direction FIG. 1-3. It is set so that edges FIG. 2-1f and FIG. 2-2g are parallel and edge FIG. 2-1f is lower than edge FIG. 2-2g, so that it does not interrupt in the cutting process later. Spring clip FIG. 1-1 is spot welded on the surface FIG. 2-2d of one of the arms FIG. 1-2h of the scissors. It is welded accordingly with what kind of operation needs to be done by the DAS (i.e. what kind of material needs to be cut). FIG. 2-4 welding attaches spring-clip surface FIG. 7-1b and scissor arm surface FIG. 2-2d together internally with two to three welding spots. Before welding, the sides of the spring-clip must be close together FIG. 6 and FIG. 2, so that after welding the cylindrical surface FIG. 6-1a of the long side of the spring-clip and the surface FIG. 2-2a of the arm FIG. 1-2h of the scissor will be pressed against each other. After welding the two sides of the spring clip are further apart FIG. 7. The first initial tension between the spring-clip and the scissors creates a better holding of materials (especially small materials) possible, in addition, it makes a deformation and formation of a gap between the spring-clip and scissors due to excess use of the DAS less likely.

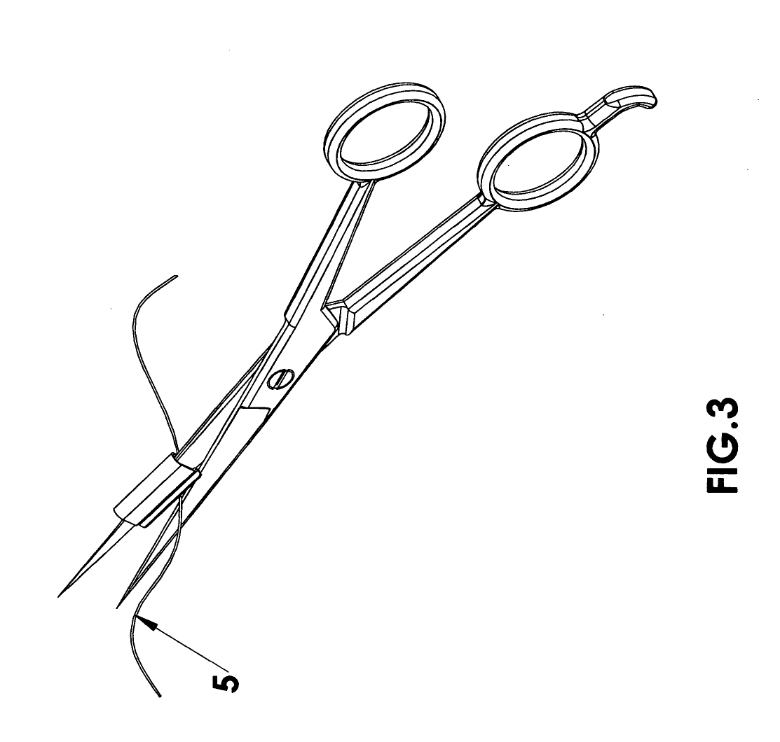

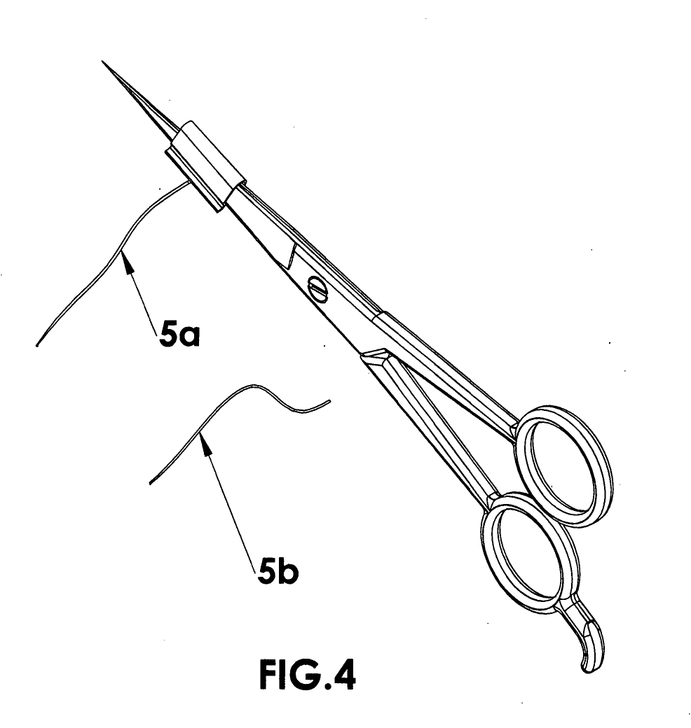

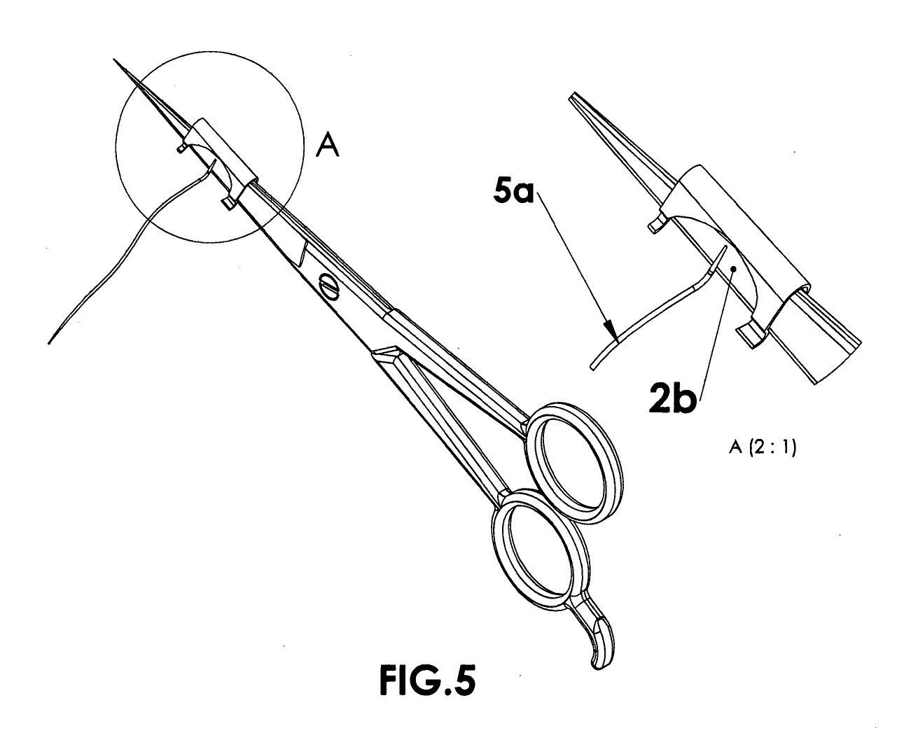

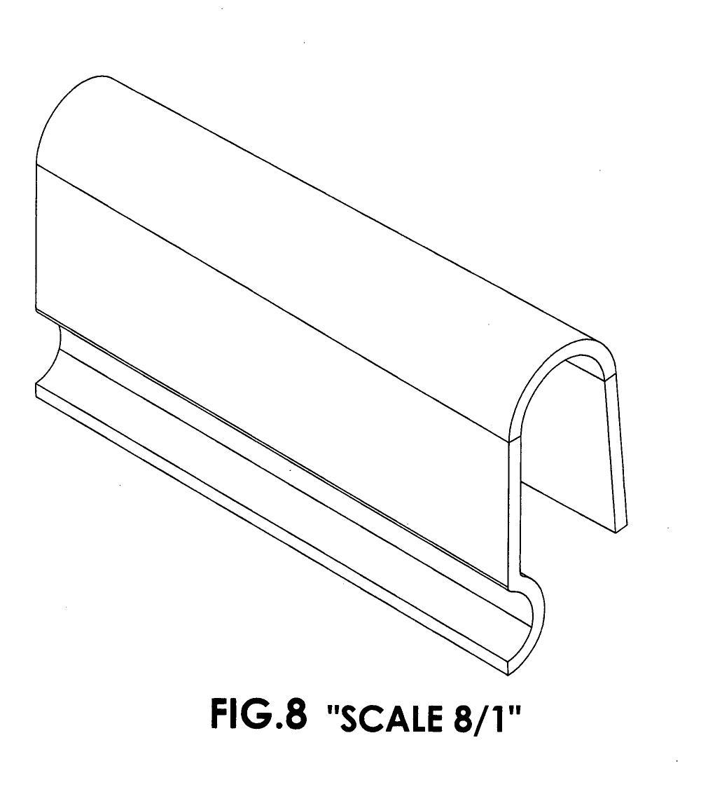

The DAS can be used just like regular scissors. While the DAS is in the open position, place the DAS on the object being cut (string FIG. 3-5), so that the spring-clip comes into contact with the string. When the cutting is in progress, scissor arms FIG. 1-2h and FIG. 1-2i cut the string FIG. 3-5 into two pieces FIG. 4-5a and FIG. 4-5b (the cutting is achieved by scissor edges FIG. 2-2a and FIG. 2-2f). Scissor arm FIG. 1-2i that is already wedged between scissor surface FIG. 1-2a and spring-clip surface FIG. 6-1a, gives the arms of the spring-clip a maximum stretch FIG. 8. At the same time the scissor arm FIG. 1-2i pushes the tip of one side of the spring FIG. 4, 5-5a and a piece of the string gets wedged between spring-clip surface FIG. 6-1a and scissor arm surface FIG. 1, 5-2b. One side of the string will be wedged between these two surfaces as long as the DAS is in the closed position FIG. 4 and FIG. 5. When the wedged string needs to be released, the DAS needs to be opened. When the DAS is opened, scissor arm FIG. 1-2i is pulled from the spring-clip, which relaxes the long side of the spring-clip and at the same time, the scissor surface FIG. 1-2b pulls a little on the string due to friction. Due to the pulling by the scissor arm and the relaxation on the spring-clip side the string is released. The sides of the spring-clip go back to their initial tension FIG. 7. DAS is intended for use as a tool in everyday life in different professions. For example, surgeons can use it during many types of surgeries, it can also be used by electricians, tailors, leatherworkers and other fields. The advantage of the DAS is that with one action it does two things, it also conserves time, energy, and it speeds up the work process. It creates a safer environment for the workplace, for example, the cut object gets held by the DAS and one does not need to worry about losing an important or dangerous piece of object being cut. The preparation of the DAS is easy and very inexpensive because one only needs to attach a spring-clip to an appropriate already existing scissor. The DAS can also help maintain a clean work environment since one piece of the object that is being cut is held by the DAS. Anyone who uses scissors can use DAS with the same ease.

1. The DAS, (a tool that can be used for different tasks and can cut a given object and at the same time hold one of the cut pieces by pulling and moving it) can be made from scissors of different types and sizes of one's choice, and the appropriate already manufactured spring-clips of many sizes and types set and connected together easily (welded if the spring-clips are metallic or mechanical if plastic).

2. The spring-clip is connected to the scissor of DAS in claim 1, by spot welding the inner surface of the short side of the spring-clip to the outer surface of the arm of the scissor that moves down.

3. In the DAS in claim 1, the spring-clip needs to be set on the tip of the arm of the scissor that moves down so that the long side of the spring-clip is on the same side as the internal surface of the arm of the scissor (the surface that comes into contact with the other arm's internal surface of the scissors), the short side of the spring-clip needs to be on the opposite side.

4. In the DAS in claim 1, the cylindrical bend that makes the two sides of the spring-clip has to be opposite the cutting edge of the arm of the scissors that moves down.

5. In the DAS in claim 1, the spring-clip is set by sliding it on the side surfaces of the arm of the scissor that moves down, so that the inside surface edge of the short side of the spring-clip is overlapping with the edge formed from sharpening the scissor.

6. In the DAS in claim 1, the final position of the arm of the scissor that moves down and the spring-clip are so, that the outside surface of the cylindrical bend at the end of the long side of the spring-clip and the smooth surface of the arm of the scissor that moves down (towards the inside of the scissors) are compressed at the cutting edge of the same arm of the scissors.

7. In the DAS in claim 1, the inside surface of the short side of the spring-clip and the outside surface of the arm of the scissors that moves down (the outside of the scissors) are attached using spot-welding.

8. To use the DAS in claim 1, open the scissors (move the arms of the scissors apart), bring the object being cut in the area between the upper and lower arms so that when the arms of the scissors are brought close together (scissors are closed) the object being cut comes into contact with the spring-clip.

9. When the object is cut into two pieces by the DAS in claim 1, one piece (located on the side of the short side of the spring-clip) falls. A small part of the other piece of the object being cut is pulled into the spring-clip (opening the arm of the spring-clip and increases the tension of the spring-clip) by the arm of the scissors that moves up, which itself gets wedged in the spring-clip. The piece of object ends up wedged between the outside surface of the arm of the scissors that moves up (outside of the scissors) and cylindrical surface of the long side of the spring-clip.

10. To release the object in the DAS the scissors need to be opened (the arms of the scissors need to be taken further apart) and because of friction between the outside surface of the arm of the scissors that moves down and decreasing tension (due to the sides of the spring-clip getting closer together) between the spring-clip and the same arm the object is released.

11. In the DAS in claim 1, the initial tension of any type of spring-clip (formed before welding because the distance between the two sides of the spring-clip is always smaller than the thickness of a chosen area on the arm of the scissors that moves down) between the spring clip and the inside surface arm of the scissors (after welding) that moves down, depends on the size and type of object being cut.

12. The DAS in claim 1 can be made from a flexible plastic and attached to the scissors mechanically if the object being cut and held by the DAS is light and requires gentle care.

13. The advantage of the DAS in claim 1 is that it can be made with ease because the scissors are already manufactured.

14. The DAS can also be used as regular scissors, using the parts of the scissors that don't interfere with the functional area of the spring-clip and the appropriate area on the scissors.
